(19) United States
(12) Patent Application Publication
(10) Pub. No.: US 2026/0129448 A1
(43) Pub. Date: May 7, 2026

(54) MULTI-PATH TRANSMISSION METHODS/APPARATUS/DEVICE, AND STORAGE MEDIUM

(71) Applicant: BEIJING XIAOMI MOBILE SOFTWARE CO., LTD., Beijing (CN)

(72) Inventors: Zhengyi SHANG, Beijing (CN); Wei LU, Beijing (CN)

(21) Appl. No.: 19/114,443

(22) PCT Filed: Sep. 26, 2022
(86) PCT No.: PCT/CN2022/121494

§ 371 Date: Mar. 22, 2025

(51) Int. Cl. H04W 12/08; H04W 8/22; H04W 12/033; H04W 12/10; H04W 92/18

(52) U.S. Cl. CPC H04W 12/08; H04W 8/22; H04W 12/033; H04W 12/10; H04W 92/18

(57) ABSTRACT

A multi-path transmission method includes: acquiring a security policy for a first service, in which, the security policy for the first service is configured for multi-path transmission of the first service, the multi-path transmission of the first service includes a first path for communication between the first UE and a base station, and a second path for communication between the first UE and the base station via a second UE; and performing the multi-path transmission of the first service according to the security policy for the first service.

### CROSS-REFERENCE TO RELATED APPLICATION

This application is a U.S. national phase of International Application No. PCT/CN 2022/121494, filed Sep. 26, 2022, the entire content of which is incorporated herein by reference.

### TECHNICAL FIELD

The disclosure relates to the field of communication technology, in particular to a multi-path transmission method/apparatus/device and a storage medium.

### BACKGROUND

In communication systems, a user equipment (UE) implements multi-path transmission with a base station over multiple paths, to improve reliability and the rate of data transmission. FIG. 1a is a schematic diagram of a structure of a multi-path transmission provided by an embodiment of the present disclosure. As shown in FIG. 1a, a remote UE communicates with the base station over a direct communication path and an indirect communication path, respectively.

### SUMMARY

In a first aspect, the present disclosure provides a multi-path transmission method. The method includes:
acquiring, by a first user equipment (UE), or a second UE, or a base station, a security policy for a first service, in which, the security policy for the first service is configured for multi-path transmission of the first service, the multi-path transmission of the first service includes a first path for communication between the first UE and the base station, and a second path for communication between the first UE and the base station via the second UE; and
performing, by the first UE, or the second UE, or the base station, the multi-path transmission of the first service according to the security policy for the first service.

In a second aspect, the present disclosure provides a multi-path transmission method. The method includes:
sending, by a policy control function (PCF) network element or a session management function (SMF) network element, a security policy for a first service, in which, the security policy for the first service is configured for multi-path transmission of the first service, the multi-path transmission of the first service includes a first path for communication between a first UE and a base station, and a second path for communication between the first UE and the base station via a second UE. In a third aspect, the disclosure provides a communication device. The communication device includes a processor and a memory having a computer program stored thereon, in which, the processor is configure to:
acquire a security policy for a first service, in which, the security policy for the first service is configured for multi-path transmission of the first service, the multi-path transmission of the first service includes a first path for communication between the first UE and a base station, and a second path for communication between the first UE and the base station via a second UE; and
perform the multi-path transmission of the first service according to the security policy for the first service.

### BRIEF DESCRIPTION OF THE DRAWINGS

The above-mentioned and/or additional aspects and advantages of the present disclosure will be apparent and readily understood from the following description of embodiments taken in combination with the accompanying drawings, in which:

FIG. 1a is a schematic diagram of a structure of a multi-path transmission provided by an embodiment of the present disclosure

FIG. 1b is a schematic diagram of an architecture of a communication system provided by an embodiment of the disclosure.

FIG. 2 is a flowchart of a multi-path transmission method provided by an embodiment of the disclosure.

FIG. 3a is a flowchart of a multi-path transmission method provided by an embodiment of the disclosure.

FIG. 3b is a flowchart of a multi-path transmission method provided by an embodiment of the disclosure.

FIG. 4 is a flowchart of a multi-path transmission method provided by an embodiment of the disclosure.

FIG. 5a is a flowchart of a multi-path transmission method provided by an embodiment of the disclosure.

FIG. 5b is a flowchart of a multi-path transmission method provided by an embodiment of the disclosure.

FIG. 6 is a flowchart of a multi-path transmission method provided by an embodiment of the disclosure.

FIG. 7a is a flowchart of a multi-path transmission method provided by an embodiment of the disclosure.

FIG. 7b is a flowchart of a multi-path transmission method provided by an embodiment of the disclosure.

FIG. 8a is a flowchart of a multi-path transmission method provided by an embodiment of the disclosure.

FIG. 8b is a flowchart of a multi-path transmission method provided by an embodiment of the disclosure.

FIG. 9a is a flowchart of a multi-path transmission method provided by an embodiment of the disclosure.

FIG. 9b is a flowchart of a multi-path transmission method provided by an embodiment of the disclosure.

FIG. 10 is a schematic diagram of a structure of a communication device provided by an embodiment of the disclosure.

FIG. 11 is a schematic diagram of a structure of a communication device provided by an embodiment of the disclosure.

FIG. 12 is a schematic diagram of a structure of a communication device provided by an embodiment of the disclosure.

FIG. 13 is a schematic diagram of a structure of a communication device provided by an embodiment of the disclosure.

FIG. 14 is a schematic diagram of a structure of a communication device provided by an embodiment of the disclosure.

FIG. 15 is a schematic diagram of a structure of a communication system provided by an embodiment of the disclosure.

FIG. 16 is a block diagram of a communication device provided by an embodiment of the disclosure.

FIG. 17 is a schematic diagram of a structure of a chip provided by another embodiment of the disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with embodiments of the disclosure. Instead, they are merely examples of apparatuses and methods consistent with aspects related to the disclosure as recited in the appended claims.

The terms used in the disclosure are only for the purpose of describing specific embodiments, and are not intended to limit embodiments of the disclosure. The singular forms of “a” and “the” used in the disclosure are also intended to include plural forms, unless the context clearly indicates other meanings. It is understandable that the term “and/or” as used herein refers to and includes any or all possible combinations of one or more associated listed items.

It is understandable that although the terms “first”, “second”, and “third” may be used in embodiments of the disclosure to describe various types of information, the information should not be limited to these terms. These terms are only used to distinguish the same type of information from each other. For example, without departing from the scope of the disclosure, the first information may also be referred to as the second information, and similarly, the second information may also be referred to as the first information. Depending on the context, the terms “if” and “in case of” as used herein may be interpreted as “when”, “upon” or “in response to determining”.

Embodiments of the disclosure are described in detail below, examples of which are illustrated in the accompanying drawings, in which the same or similar reference numerals refer to the same or similar elements throughout. The embodiments described below with reference to the accompanying drawings are exemplary and are intended to be used to explain the disclosure, but should not be constructed as limiting the disclosure.

For convenience of understanding, terms involved in the present disclosure are first introduced.
1. Remote UE
A UE capable of communicating with a base station via another UE.
2. Relay UE
A UE configured to implement relay communication between another UE and the base station.
3. Multi-path transmission
Signaling and/or user plane (UP) data simultaneous transmission between the remote UE and the base station over multiple paths, for example, signaling and/or user plane (UP) data for transmission of Prose service.
4. Proximity based service (Prose) service
The Prose service is a service provided by a 3rd Generation Partnership Project (3GPP) system for user equipment (UEs) located in close proximity. The ProSe service may support a variety of application scenarios such as public safety, Internet of Things, and Internet of Vehicles. The ProSe service mainly includes two aspects of ProSe discovery and ProSe communication. The ProSe discovery refers to a process in which the UE discovers nearby UEs that support the corresponding ProSe service by means of a broadcast message. The ProSe communication refers to a process of establishing a secure communication channel between UEs to perform secure data communication.

During single-path transmission, security policies configured by a network for a UE may include: required protection (REQUIRED), not needed protection (NOT NEEDED), and preferred protection (PREFERRED). The above-mentioned “REQUIRED” means that security protection is required, at this case, the UE shall only establish a connection with a UE that uses non-NULL confidentiality and/or integrity algorithm. The above-mentioned “NOT NEEDED” means that the UE shall only establish a connection with no security protection. The above-mentioned “PREFFERED” means that the UE may try to establish a connection with security protection but may will accept the connection with no security protection. However, during multi-path transmission, if the network configures security policies for different paths in the multiple paths, respectively, the security policies for different paths may be different.

It is understandable that during the multi-path transmission, if the security policies of different paths are not consistent, information data leakage may occur. For example, if a security policy of a direct communication path is: enabling confidentiality and/or integrity protection, and a security policy of an indirect communication path is: not enabling confidentiality and/or integrity protection. Thus, in a case the remote UE transmits data with higher confidentiality over multiple paths, transmitting the data over the indirect communication path may be easily intercepted, resulting in information data leakage. Therefore, how to make the security policies of different paths consistent during the multi-path transmission to ensure the information security in the multi-path transmission is an urgent technical problem to be solved. The present disclosure is a solution proposed to solve this technical problem.

In order to better understand a multi-path transmission method disclosed in an embodiment of the present disclosure, a communication system to which an embodiment of the present disclosure is applicable is first described below.

Reference is made to FIG. 1b, which is a schematic diagram of a structure of a communication system provided by an embodiment of the disclosure. The communication system may include, but is not limited to, one base station and at least two terminal devices. The number and the form of devices illustrated in FIG. 1b are only for examples and do not constitute a limitation on embodiments of the disclosure. The communication system may include two or more base stations and two or more terminal devices in practical applications. The communication system as illustrated in FIG. 1b may include, for example, a base station 11, a first UE 12 and a second UE 13.

It is noteworthy that the technical solutions of the embodiments of the disclosure may be applied to various communication systems, such as, a long term evolution (LTE) system, a 5th generation (5G) mobile communication system, a 5G NR (new radio) system, or other future new mobile communication systems, etc.

The base station 11 in embodiments of the disclosure is an entity on a network side for transmitting or receiving signals. For example, the base station 11 may be an evolved NodeB (eNB), a transmission reception point (TRP), a next generation NodeB (gNB) in a NR system, a base station in other future mobile communication systems, or an access node in a wireless fidelity (WiFi) system. The specific technology and specific device form adopted by the network device are not limited in the embodiments of the disclosure. The network device according to embodiments of the disclosure may be composed of a central unit (CU) and distributed units (DUs). The CU may also be referred to as a control unit. The use of CU-DU structure allows to divide a protocol layer of the network device, such as a base station, such that some of the protocol layer functions are placed in the CU for centralized control, and some or all of the remaining protocol layer functions are distributed in the DUs, and the DUs are centrally controlled by the CU.

The first UE 12 and the second UE 13 in embodiments of the disclosure are entities on a user side for receiving or transmitting signals, such as a cellular phone. The terminal device may also be referred to as a terminal, a user equipment (UE), a mobile station (MS), a mobile terminal (MT), and the like. The terminal device can be a car with communication functions, a smart car, a mobile phone, a wearable device, a Pad, a computer with wireless transceiver functions, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The specific technology and specific device form adopted by the terminal device are not limited in embodiments of the present disclosure.

It is understandable that the communication system described in embodiments of the present disclosure is intended to clearly illustrate the technical solutions according to embodiments of the present disclosure, and does not constitute a limitation on the technical solutions according to embodiments of the present disclosure. It is understandable by those skilled in the art that as system architectures evolve and new business scenarios emerge, the technical solutions according to embodiments of the disclosure are also applicable to similar technical problems.

A multi-path transmission method/apparatus/device and a storage medium provided by embodiments of the present disclosure will be described in detail below with reference to the accompanying drawings.

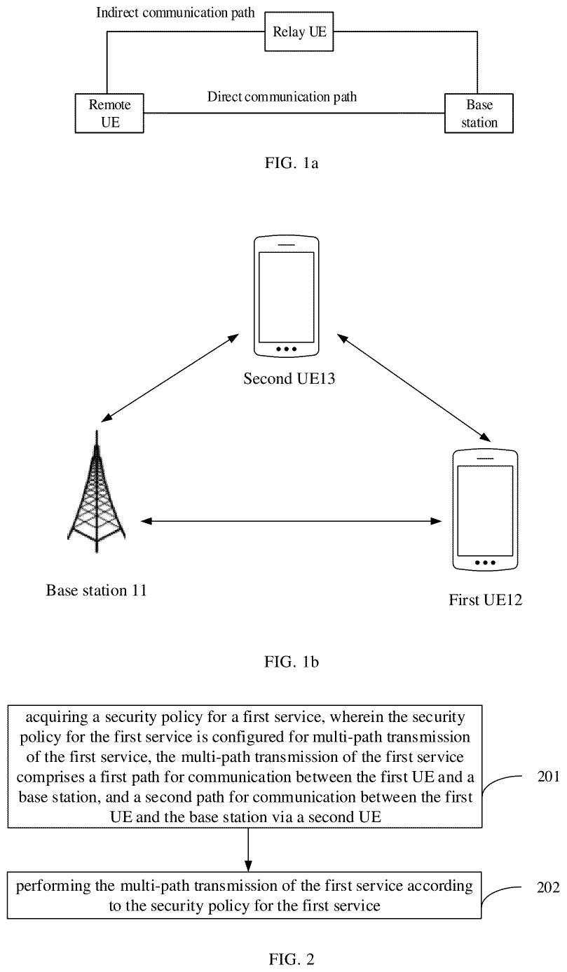

FIG. 2 is a flowchart of a multi-path transmission method provided by an embodiment of the disclosure. The method is performed by a first UE. As illustrated in FIG. 2, the multi-path transmission method may include the following step.

At step 201, a security policy for a first service is acquired, in which, the security policy for the first service is configured for multi-path transmission of the first service, the multi-path transmission of the first service includes a first path for communication between the first UE and a base station, and a second path for communication between the first UE and the base station via a second UE.

In an embodiment of the present disclosure, the above first UE may be a remote UE, the second UE may be a relay UE, and the first service may include a proximity based service (Prose) service. The first path may be a direct communication path in FIG. 1a, and the second path may be an indirect communication path in FIG. 1a. The first path includes a Uu link between the first UE and the base station, and the second path includes a PC5 link between the first UE and the second UE and a Uu link between the second UE and the base station. And, the multi-path transmission may be configured to serve the same first service, that is, the Uu link between the first UE and the base station, the PC5 link between the first UE and the second UE, and the Uu link between the second UE and the base station are all used to serve the same first service.

In an example, the first path is also referred to as a “direct transmission path”, “direct path”, “direct communication path”, “3GPP access”, etc. The second path is also referred to as an “indirect transmission path”, “indirect path”, “indirect communication path”, “non-3GPP access”, etc.

In an embodiment of the present disclosure, the PC5 link may be established via negotiation between the first UE and the second UE based on their respective security policies acquired, and the Uu link may be established by the base station based on its security policy acquired. The security policies acquired by the first UE and the second UE are sent by a policy control function (PCF) network element, for example, the PCF network element may send the security policy to the first UE and the second UE during a service authorization procedure. The security policy acquired by the base station is sent by a session management function (SMF) network element, for example, the SMF network element may send the security policy to the base station during a protocol data unit (PDU) session establishment procedure. And, the security policy corresponding to each link is mainly a security policy associated with the first service served by the link. The security policy in the present disclosure is associated with the first service (that is, the same first service corresponds to the same security policy), and the multiple paths are used to serve the same first service, thus, for the same first service, the security policy sent by the PCF to the first UE and the second UE shall be the same as the security policy sent by the SMF to the base station.

Furthermore, in an embodiment of the present disclosure, the security policy may be any one of:
required protection (REQUIRED); or
not needed protection (NOT NEEDED).

It can be seen from the above content that in an embodiment of the present disclosure, the security policy is not set as PREFERRED (preferred protection) by the network for the UE like in single-path transmission. Therefore, it may ensure that different paths in the multi-path transmission can use the same security policy and the same security activation status to transmit signaling data and/or user plane (UP) data, further ensuring the information security in the multi-path transmission.

The following is an introduction to the specific principle of the method for implementing “ensuring that different paths in multi-path transmission can use the same security policy to transmit signaling data and/or UP data” in the present disclosure.

If in a multi-path transmission scenario, the security policy configured by the network for a single-path UE is directly used, and the security policy includes required protection (REQUIRED), not needed protection (NOT NEEDED), and preferred protection (PREFERRED), then the following situations are present.

If the security policies acquired by the first UE, the second UE and the base station are all set as REQUIRED, the first UE and the second UE may establish via negotiation a PC5 link that requires security protection based on the security policy “REQUIRED”. And the base station may establish a Uu link that requires security protection with the first UE and the second UE respectively based on the security policy “REQUIRED”. That is, different paths use the same security policy of “required security protection”.

If the security policies acquired by the first UE, the second UE and the base station are all set as NOT NEEDED, the first UE and the second UE may establish via negotiation a PC5 link that does not need security protection based on the security policy “NOT NEEDED”. And the base station may establish a Uu link that does not need security protection with the first UE and the second UE respectively based on the security policy “NOT NEEDED”. That is, different paths use the same security policy of “not needed security protection”.

If the security policies acquired by the first UE, the second UE and the base station are all set as PREFERRED, then the first UE and the second UE may establish via negotiation a PC5 link that does not need security protection, or a PC5 link that requires security protection, based on the security policy “PREFERRED”. And the base station may independently determine to establish a Uu link that does not need security protection, or a Uu link that requires security protection, based on the security policy “PREFERRED”. At this case, a security activation status of the PC5 link finally established may be different from a security activation status of the Uu link finally established, for example, the first UE and the second UE may establish via negotiation the PC5 link that does not need security protection, while the base station may independently determine to establish the Uu link that requires security protection.

It can be seen that in a scenario of multi-path transmission, to ensure consistency between the security activation status of the PC5 link finally established and the security activation status of the Uu link finally established always, the security policy should only be set as “REQUIRED” or “NOT NEEDED”. If the security policy is set as “PREFERRED”, it is difficult to ensure the consistency between the security activation status of the PC5 link finally established and the security activation status of the Uu link finally established always. Therefore, in the present disclosure, the security policy is set as REQUIRED, or, NOT NEEDED, rather than “PREFERRED”, which may ensure the consistency between the security activation status of the PC5 link finally established and the security activation status of the Uu link finally established always, that is, ensure that the direct transmission path and the indirect transmission path use the same security policy and the same security activation status to ensure the information security in the multi-path transmission.

In addition, it is noted that, in an embodiment of the present disclosure, the above security policy may specifically include at least one of the following policies:
a security policy for PC5 link; or
a security policy for Uu link.

The security policy for the PC5 link is consistent with the security policy for the Uu link.

Further, in an embodiment of the present disclosure, the security policy may include a UP security policy and/or a signaling security policy. The UP security policy may include at least one of a UP integrity protection policy and a UP confidentiality protection policy, and the signaling security policy may include at least one of a signaling integrity protection policy and a signaling confidentiality protection policy.

In an embodiment of the present disclosure, the direct transmission path and the indirect transmission path using the same security policy can be understood as: all security policies used in the direct transmission path and the indirect transmission path being the same, such as the UP security policy and the signaling security policy used in the direct transmission path are the same as the UP security policy and the signaling security policy used in the indirect transmission path.

For example, if the security policy includes the UP integrity protection policy, the UP confidentiality protection policy, the signaling integrity protection policy, and the signaling confidentiality protection policy, in a case that the security policy is set as “REQUIRED”, it means that both the PC5 link and the Uu link require security protection corresponding to the security policy. For example, in a case that the UP integrity protection policy is set is “REQUIRED”, the UP integrity protection for both the PC5 link and the Uu link is activated. In a case that the UP confidentiality protection policy is “REQUIRED”, the UP confidentiality protection for both the PC5 link and the Uu link is activated. In a case that the signaling integrity protection policy is “REQUIRED”, the signaling integrity protection for both the PC5 link and the Uu link is activated. In a case that the signaling confidentiality protection policy is “REQUIRED”, the signaling confidentiality protection for both the PC5 link and the Uu link is activated.

In a case that the security policy is set as “NOT NEEDED”, it means that neither the PC5 link nor the Uu link needs the security protection corresponding to the security policy. For example, in a case that the UP integrity protection policy is set is “NOT NEEDED”, the UP integrity protection for both the PC5 link and the Uu link is deactivated. In a case that the UP confidentiality protection policy is “NOT NEEDED”, the UP confidentiality protection for both the PC5 link and the Uu link is deactivated. In a case that the signaling integrity protection policy is “NOT NEEDED”, the signaling integrity protection for both the PC5 link and the Uu link is deactivated. In a case that the signaling confidentiality protection policy is “NOT NEEDED”, the signaling confidentiality protection for both the PC5 link and the Uu link is deactivated.

In another embodiment of the present disclosure, the direct transmission path and the indirect transmission path using the same security policy can be understood as: signaling security policies used in the direct transmission path and the indirect transmission path being the same, and/or, UP security policies used in the direct transmission path and the indirect transmission path being the same, in which, the signaling security policies may be different from the UP security policies.

For example, if the security policy includes the UP integrity protection policy, the UP confidentiality protection policy, the signaling integrity protection policy, and the signaling confidentiality protection policy, in a case that the signaling integrity/confidentiality security policy is “REQUIRED” and the UP integrity/encryption security policy is “NOT NEEDED”, it means that the PC5 link and Uu link require the signaling integrity protection/signaling confidentiality protection, but do not need the UP integrity protection/UP confidentiality protection.

In another embodiment of the present disclosure, the direct transmission path and the indirect transmission path using the same security policy can be understood as: UP integrity protection policies used in the direct transmission path and the indirect transmission path being the same, UP confidentiality protection policies used in the direct transmission path and the indirect transmission path being the same, signaling integrity protection policies used in the direct transmission path and the indirect transmission path being the same, and signaling confidentiality protection policies used in the direct transmission path and the indirect transmission path being the same, in which, the UP integrity protection policies, the UP confidentiality protection policies, the signaling integrity protection policies, and the signaling confidentiality protection policies may be different from each other.

For example, if the security policy includes the UP integrity protection policy, the UP confidentiality protection policy, the signaling integrity protection policy, and the signaling confidentiality protection policy, in a case that the signaling integrity security policy is “NOT NEEDED”, the signaling confidentiality security policy is “REQUIRED”, the UP integrity security policy is “NOT NEEDED”, and the UP confidentiality security policy is “REQUIRED”, it means that the PC5 link and the UU link require the UP confidentiality protection and the signaling confidentiality protection, but do not need the UP integrity protection and the signaling integrity protection.

In addition, it should be noted that, in an embodiment of the present disclosure, since signaling security is always required, the signaling integrity/confidentiality security policy may always be set as “REQUIRED”.

At step 202, the multi-path transmission of the first service is performed according to the security policy for the first service.

Specifically, in an embodiment of the present disclosure, if the security policy for the first service is set as REQUIRED, the first UE can perform confidentiality and/or integrity protection on the signaling data and/or UP data transmitted over the first path and the second path during the multi-path transmission of the first service. If the security policy for the first service is set as NOT NEEDED, the signaling data and/or UP data transmitted over the first path and the second path will not be protected during the multi-path transmission of the first service.

In summary, in the multi-path transmission method provided by the present disclosure, the first UE may acquire the security policy for the first service, the security policy for the first service is configured for the multi-path transmission of the first service, the multi-path transmission of the first service includes the first path for communication between the first UE and the base station, and the second path for communication between the first UE and the base station via the second UE. Then, the first UE may perform the multi-path transmission of the first service according to the security policy for the first service. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

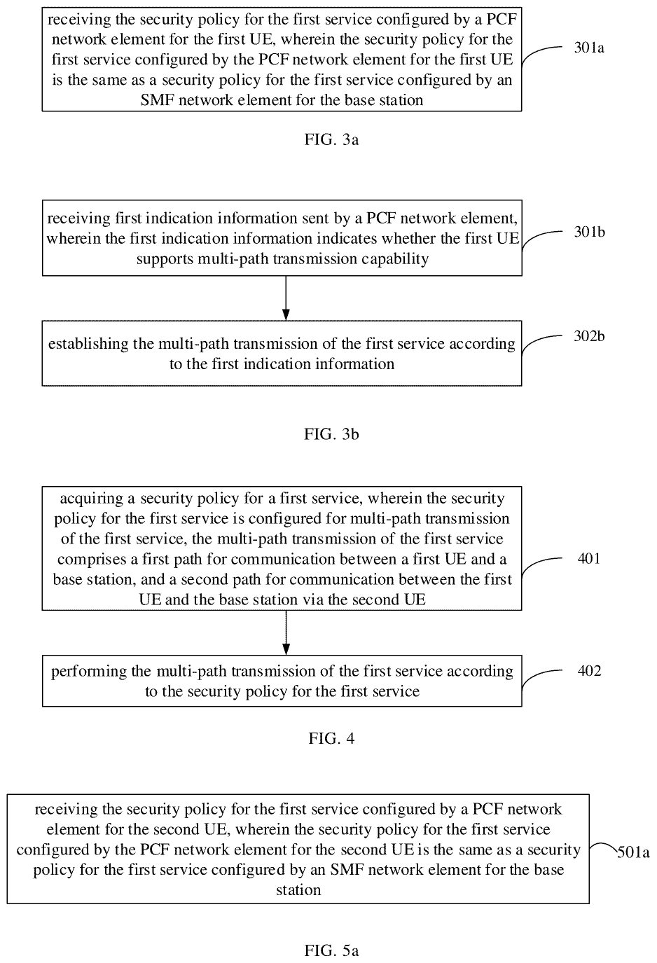

FIG. 3a is a flowchart of a multi-path transmission method provided by an embodiment of the disclosure. The method is performed by a first UE. As illustrated in FIG. 3a, the multi-path transmission method may include the following step.

At step 301a, the security policy for the first service configured by a PCF network element for the first UE is received. The security policy for the first service configured by the PCF network element for the first UE is the same as a security policy for the first service configured by an SMF network element for the base station.

In summary, in the multi-path transmission method provided by the present disclosure, the first UE may acquire the security policy for the first service, the security policy for the first service is configured for the multi-path transmission of the first service, the multi-path transmission of the first service includes the first path for communication between the first UE and the base station, and the second path for communication between the first UE and the base station via the second UE. Then, the first UE may perform the multi-path transmission of the first service according to the security policy for the first service. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

FIG. 3b is a flowchart of a multi-path transmission method provided by an embodiment of the disclosure. The method is performed by a first UE. As illustrated in FIG. 3b, the multi-path transmission method may include the following step.

At step 301b, first indication information sent by a PCF network element is received. The first indication information indicates whether the first UE supports multi-path transmission capability.

In an embodiment of the present disclosure, the first indication information may be included in a user equipment routing selection policy (URSP) rule.

At step 302b, the multi-path transmission of the first service is established according to the first indication information.

Specifically, in an embodiment of the present disclosure, the first UE establishes the multi-path transmission of the first service in response to the first indication information indicating that the first UE supports the multi-path transmission capability. For example, the first path between the first UE and the base station is established (i.e., a Uu link between the first UE and the base station is established), and the second path is established. Establishing the second path includes establishing a PC5 link between the second UE and the first UE in the second path and establishing a Uu link between the second UE and the base station.

The first UE establishes the first path based on an indication of the base station, and establishes the PC5 link in the second path by negotiating with the second UE. For details on how to establish the first path and the second path, reference is made on the description in the prior arts.

In summary, in the multi-path transmission method provided by the present disclosure, the first UE may acquire the security policy for the first service, the security policy for the first service is configured for the multi-path transmission of the first service, the multi-path transmission of the first service includes the first path for communication between the first UE and the base station, and the second path for communication between the first UE and the base station via the second UE. Then, the first UE may perform the multi-path transmission of the first service according to the security policy for the first service. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

FIG. 4 is a flowchart of a multi-path transmission method provided by an embodiment of the disclosure. The method is performed by a second UE. As illustrated in FIG. 4, the multi-path transmission method may include the following step.

At step 401, a security policy for a first service is acquired, in which, the security policy for the first service is configured for multi-path transmission of the first service, the multi-path transmission of the first service includes a first path for communication between a first UE and a base station, and a second path for communication between the first UE and the base station via the second UE.

At step 402, the multi-path transmission of the first service is performed according to the security policy for the first service.

Specifically, in an embodiment of the present disclosure, if the security policy for the first service is set as REQUIRED, the second UE can perform confidentiality and/or integrity protection on the signaling data and/or UP data transmitted over the second path during the multi-path transmission of the first service. If the security policy for the first service is set as NOT NEEDED, the signaling data and/or UP data transmitted over the second path will not be protected during the multi-path transmission of the first service.

For other detailed introductions of steps 401-402, reference may be made on the description of the above embodiments, which will not be repeated in the present disclosure.

In summary, in the multi-path transmission method provided by the present disclosure, the second UE may acquire the security policy for the first service, the security policy for the first service is configured for the multi-path transmission of the first service, the multi-path transmission of the first service includes the first path for communication between the first UE and the base station, and the second path for communication between the first UE and the base station via the second UE. Then, the second UE may perform the multi-path transmission of the first service according to the security policy for the first service. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

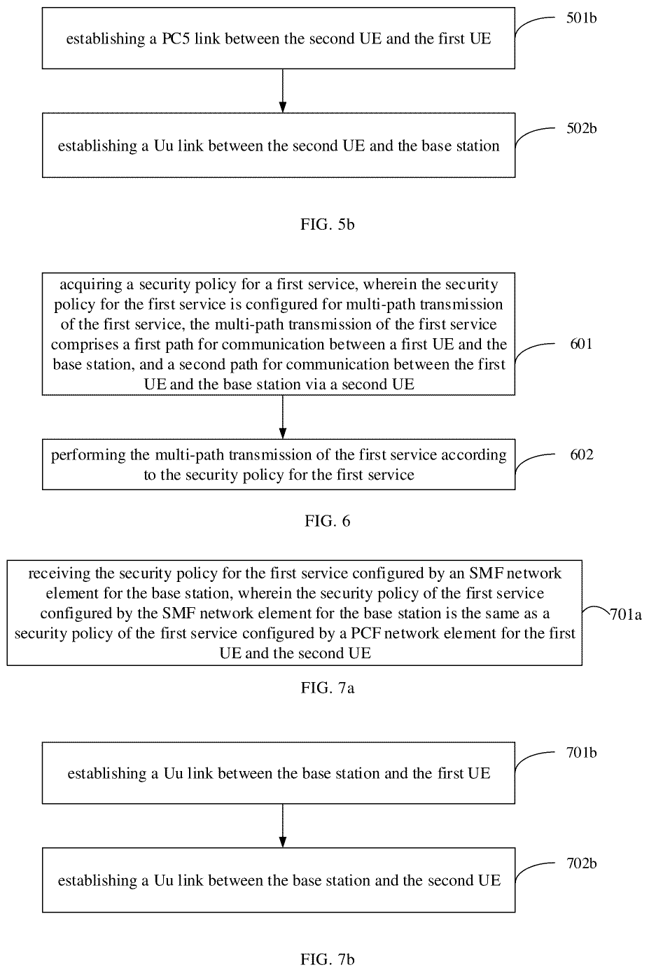

FIG. 5a is a flowchart of a multi-path transmission method provided by an embodiment of the disclosure. The method is performed by a second UE. As illustrated in FIG. 5a, the multi-path transmission method may include the following step.

At step 501a, the security policy for the first service configured by a PCF network element for the second UE is received, in which, the security policy for the first service configured by the PCF network element for the second UE is the same as a security policy for the first service configured by an SMF network element for the base station.

In summary, in the multi-path transmission method provided by the present disclosure, the second UE may acquire the security policy for the first service, the security policy for the first service is configured for the multi-path transmission of the first service, the multi-path transmission of the first service includes the first path for communication between the first UE and the base station, and the second path for communication between the first UE and the base station via the second UE. Then, the second UE may perform the multi-path transmission of the first service according to the security policy for the first service. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

FIG. 5b is a flowchart of a multi-path transmission method provided by an embodiment of the disclosure. The method is performed by a second UE. As illustrated in FIG. 5b, the multi-path transmission method may include the following step.

At step 501b, a PC5 link between the second UE and the first UE is established.

At step 502b, a Uu link between the second UE and the base station is established.

For other detailed introductions of steps 501-502, reference may be made on the description of the above embodiments, which will not be repeated in the present disclosure.

In summary, in the multi-path transmission method provided by the present disclosure, the second UE may acquire the security policy for the first service, the security policy for the first service is configured for the multi-path transmission of the first service, the multi-path transmission of the first service includes the first path for communication between the first UE and the base station, and the second path for communication between the first UE and the base station via the second UE. Then, the second UE may perform the multi-path transmission of the first service according to the security policy for the first service. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

FIG. 6 is a flowchart of a multi-path transmission method provided by an embodiment of the disclosure. The method is performed by a base station. As illustrated in FIG. 6, the multi-path transmission method may include the following step.

At step 601, a security policy for a first service is acquired, in which, the security policy for the first service is configured for multi-path transmission of the first service, the multi-path transmission of the first service includes a first path for communication between a first UE and the base station, and a second path for communication between the first UE and the base station via a second UE.

At step 602, the multi-path transmission of the first service is performed according to the security policy for the first service.

For other detailed introductions of steps 601-602, reference may be made on the description of the above embodiments, which will not be repeated in the present disclosure.

In summary, in the multi-path transmission method provided by the present disclosure, the base station may acquire the security policy for the first service, the security policy for the first service is configured for the multi-path transmission of the first service, the multi-path transmission of the first service includes the first path for communication between the first UE and the base station, and the second path for communication between the first UE and the base station via the second UE. Then, the base station may perform the multi-path transmission of the first service according to the security policy for the first service. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

FIG. 7a is a flowchart of a multi-path transmission method provided by an embodiment of the disclosure. The method is performed by a base station. As illustrated in FIG. 7a, the multi-path transmission method may include the following step.

At step 701a, the security policy for the first service configured by an SMF network element for the base station is received, in which, the security policy of the first service configured by the SMF network element for the base station is the same as a security policy of the first service configured by a PCF network element for the first UE and the second UE.

In summary, in the multi-path transmission method provided by the present disclosure, the base station may acquire the security policy for the first service, the security policy for the first service is configured for the multi-path transmission of the first service, the multi-path transmission of the first service includes the first path for communication between the first UE and the base station, and the second path for communication between the first UE and the base station via the second UE. Then, the base station may perform the multi-path transmission of the first service according to the security policy for the first service. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

FIG. 7b is a flowchart of a multi-path transmission method provided by an embodiment of the disclosure. The method is performed by a base station. As illustrated in FIG. 7b, the multi-path transmission method may include the following step.

At step 701b, a Uu link between the base station and the first UE is established.

At step 702b, a Uu link between the base station and the second UE is established.

For other detailed introductions of steps 701b-702b, reference may be made on the description of the above embodiments, which will not be repeated in the present disclosure.

In summary, in the multi-path transmission method provided by the present disclosure, the base station may acquire the security policy for the first service, the security policy for the first service is configured for the multi-path transmission of the first service, the multi-path transmission of the first service includes the first path for communication between the first UE and the base station, and the second path for communication between the first UE and the base station via the second UE. Then, the base station may perform the multi-path transmission of the first service according to the security policy for the first service. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

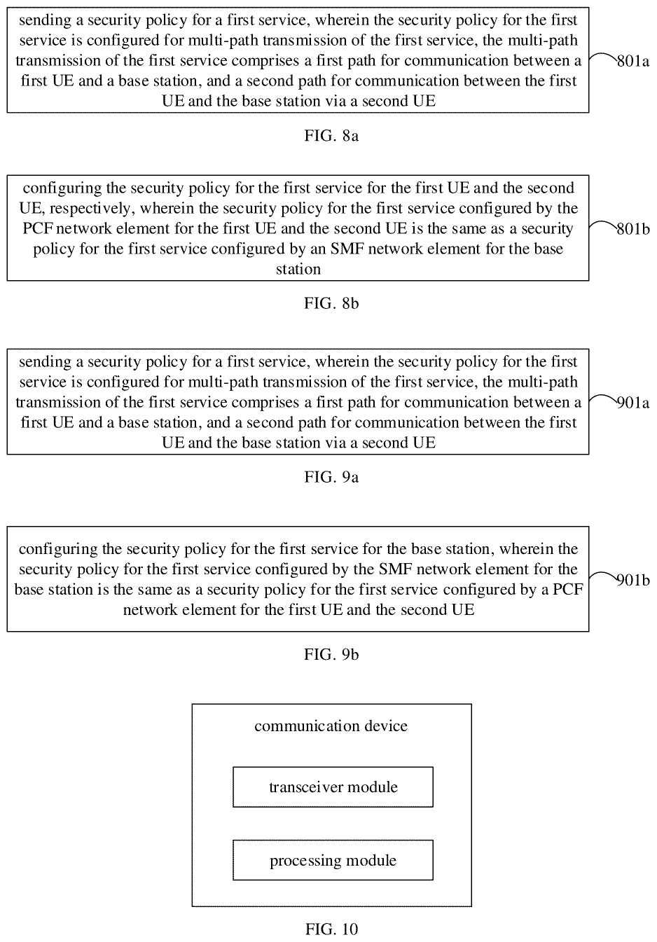

FIG. 8a is a flowchart of a multi-path transmission method provided by an embodiment of the disclosure. The method is performed by a PCF network element. As illustrated in FIG. 8a, the multi-path transmission method may include the following step.

At step 801a, a security policy for a first service is sent, in which, the security policy for the first service is configured for multi-path transmission of the first service, the multi-path transmission of the first service includes a first path for communication between a first UE and a base station, and a second path for communication between the first UE and the base station via a second UE.

For other detailed introductions of step 801a, reference may be made on the description of the above embodiments, which will not be repeated in the present disclosure.

In summary, in the multi-path transmission method provided by the present disclosure, the PCF network element may send the security policy for the first service, the security policy for the first service is configured for the multi-path transmission of the first service, the multi-path transmission of the first service includes the first path for communication between the first UE and the base station, and the second path for communication between the first UE and the base station via the second UE. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

FIG. 8b is a flowchart of a multi-path transmission method provided by an embodiment of the disclosure. The method is performed by a PCF network element. As illustrated in FIG. 8b, the multi-path transmission method may include the following step.

At step 801b, the security policy for the first service is configured for the first UE and the second UE, respectively, in which, the security policy for the first service configured by the PCF network element for the first UE and the second UE is the same as a security policy for the first service configured by an SMF network element for the base station.

For other detailed introductions of step 801b, reference may be made on the description of the above embodiments, which will not be repeated in the present disclosure.

In summary, in the multi-path transmission method provided by the present disclosure, the PCF network element may send the security policy for the first service, the security policy for the first service is configured for the multi-path transmission of the first service, the multi-path transmission of the first service includes the first path for communication between the first UE and the base station, and the second path for communication between the first UE and the base station via the second UE. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

FIG. 9a is a flowchart of a multi-path transmission method provided by an embodiment of the disclosure. The method is performed by an SMF network element. As illustrated in FIG. 9a, the multi-path transmission method may include the following step.

At step 901a, a security policy for a first service is sent, in which, the security policy for the first service is configured for multi-path transmission of the first service, the multi-path transmission of the first service includes a first path for communication between a first UE and a base station, and a second path for communication between the first UE and the base station via a second UE.

For other detailed introductions of step 901a, reference may be made on the description of the above embodiments, which will not be repeated in the present disclosure.

In summary, in the multi-path transmission method provided by the present disclosure, the SMF network element may send the security policy for the first service, the security policy for the first service is configured for the multi-path transmission of the first service, the multi-path transmission of the first service includes the first path for communication between the first UE and the base station, and the second path for communication between the first UE and the base station via the second UE. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

FIG. 9b is a flowchart of a multi-path transmission method provided by an embodiment of the disclosure. The method is performed by an SMF network element. As illustrated in FIG. 9b, the multi-path transmission method may include the following step.

At step 901b, the security policy for the first service is configured for the base station, in which, the security policy for the first service configured by the SMF network element for the base station is the same as a security policy for the first service configured by a PCF network element for the first UE and the second UE.

For other detailed introductions of step 901ba, reference may be made on the description of the above embodiments, which will not be repeated in the present disclosure.

In summary, in the multi-path transmission method provided by the present disclosure, the SMF network element may send the security policy for the first service, the security policy for the first service is configured for the multi-path transmission of the first service, the multi-path transmission of the first service includes the first path for communication between the first UE and the base station, and the second path for communication between the first UE and the base station via the second UE. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

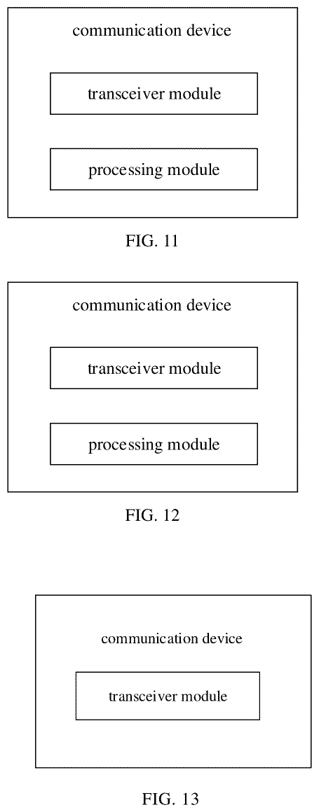

FIG. 10 is a schematic diagram of a structure of a communication device provided by an embodiment of the disclosure. As illustrated in FIG. 10, the device may include:
a transceiver module, configured to acquire a security policy for a first service, in which, the security policy for the first service is configured for multi-path transmission of the first service, the multi-path transmission of the first service includes a first path for communication between the first UE and a base station, and a second path for communication between the first UE and the base station via a second UE; and
a processing module, configured to perform the multi-path transmission of the first service according to the security policy for the first service.

In summary, in the communication device provided in an embodiment of the present disclosure, the first UE may acquire the security policy for the first service, the security policy for the first service is configured for the multi-path transmission of the first service, the multi-path transmission of the first service includes the first path for communication between the first UE and the base station, and the second path for communication between the first UE and the base station via the second UE. Then, the first UE may perform the multi-path transmission of the first service according to the security policy for the first service. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

Optionally, in an embodiment of the present disclosure, the security policy includes any one of:
required protection (REQUIRED); or
not needed protection (NOT NEEDED).

Optionally, in an embodiment of the present disclosure, the first path is a Uu link; the second path comprises a PC5 link between the first UE and the second UE and a Uu link between the second UE and the base station.

Optionally, in an embodiment of the present disclosure, the security policy for the first service includes at least one of the following policies:
a user plane (UP) integrity protection and/or confidentiality protection policy for a PC5 link;
a UP integrity protection and/or confidentiality protection policy for a Uu link;
a signaling integrity protection and/or confidentiality protection policy for a PC5 link; or
a signaling integrity protection and/or confidentiality protection policy for a Uu link.

Optionally, in an embodiment of the present disclosure, the transceiver module is further configured to:
receive the security policy for the first service configured by a PCF network element for the first UE, in which, the security policy for the first service configured by the PCF network element for the first UE is the same as a security policy for the first service configured by an SMF network element for the base station.

Optionally, in an embodiment of the present disclosure, the device is further configured to:
receive first indication information sent by a PCF network element, in which, the first indication information indicates whether the first UE supports multi-path transmission capability; and
establish the multi-path transmission of the first service according to the first indication information.

Optionally, in an embodiment of the present disclosure, the first service includes a proximity based service (Prose) service.

FIG. 11 is a schematic diagram of a structure of a communication device provided by an embodiment of the disclosure. As illustrated in FIG. 11, the device may include:
a transceiver module, configured to acquire a security policy for a first service, in which, the security policy for the first service is configured for multi-path transmission of the first service, the multi-path transmission of the first service includes a first path for communication between a first UE and a base station, and a second path for communication between the first UE and the base station via the second UE; and
a processing module, configured to perform the multi-path transmission of the first service according to the security policy for the first service.

In summary, in the communication device provided in an embodiment of the present disclosure, the second UE may acquire the security policy for the first service, the security policy for the first service is configured for the multi-path transmission of the first service, the multi-path transmission of the first service includes the first path for communication between the first UE and the base station, and the second path for communication between the first UE and the base station via the second UE. Then, the second UE may perform the multi-path transmission of the first service according to the security policy for the first service. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

Optionally, in an embodiment of the present disclosure, the security policy includes any one of:
required protection (REQUIRED); or
not needed protection (NOT NEEDED).

Optionally, in an embodiment of the present disclosure, the first path is a Uu link; the second path comprises a PC5 link between the first UE and the second UE and a Uu link between the second UE and the base station.

Optionally, in an embodiment of the present disclosure, the security policy includes at least one of the following policies:
a UP integrity protection and/or confidentiality protection policy for a PC5 link;
a UP integrity protection and/or confidentiality protection policy for a Uu link;
a signaling integrity protection and/or confidentiality protection policy for a PC5 link; or
a signaling integrity protection and/or confidentiality protection policy for a Uu link.

Optionally, in an embodiment of the present disclosure, the transceiver module is further configured to:
receive the security policy for the first service configured by a PCF network element for the second UE, wherein the security policy for the first service configured by the PCF network element for the second UE is the same as a security policy for the first service configured by an SMF network element for the base station.

Optionally, in an embodiment of the present disclosure, the device is further configured to:
establish a PC5 link between the second UE and the first UE;
establish a Uu link between the second UE and the base station.

Optionally, in an embodiment of the present disclosure, the first service includes a proximity based service (Prose) service.

FIG. 12 is a schematic diagram of a structure of a communication device provided by an embodiment of the disclosure. As illustrated in FIG. 12, the device may include:
a transceiver module, configured to acquire a security policy for a first service, in which, the security policy for the first service is configured for multi-path transmission of the first service, the multi-path transmission of the first service includes a first path for communication between a first UE and the base station, and a second path for communication between the first UE and the base station via a second UE; and
a processing module, configured to perform the multi-path transmission of the first service according to the security policy for the first service.

In summary, in the communication device provided in an embodiment of the present disclosure, the base station may acquire the security policy for the first service, the security policy for the first service is configured for the multi-path transmission of the first service, the multi-path transmission of the first service includes the first path for communication between the first UE and the base station, and the second path for communication between the first UE and the base station via the second UE. Then, the base station may perform the multi-path transmission of the first service according to the security policy for the first service. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

Optionally, in an embodiment of the present disclosure, the security policy includes any one of:
required protection (REQUIRED); or
not needed protection (NOT NEEDED).

Optionally, in an embodiment of the present disclosure, the first path is a Uu link; the second path comprises a PC5 link between the first UE and the second UE and a Uu link between the second UE and the base station.

Optionally, in an embodiment of the present disclosure, the security policy includes at least one of the following policies:
a UP integrity protection and/or confidentiality protection policy for a PC5 link;
a UP integrity protection and/or confidentiality protection policy for a Uu link;
a signaling integrity protection and/or confidentiality protection policy for a PC5 link; or
a signaling integrity protection and/or confidentiality protection policy for a Uu link.

Optionally, in an embodiment of the present disclosure, the transceiver module is further configured to:
receive the security policy for the first service configured by an SMF network element for the base station, in which, the security policy of the first service configured by the SMF network element for the base station is the same as a security policy of the first service configured by a PCF network element for the first UE and the second UE.

Optionally, in an embodiment of the present disclosure, the device is further configured to:
establish a Uu link between the base station and the first UE;
establish a Uu link between the base station and the second UE.

Optionally, in an embodiment of the present disclosure, the first service includes a proximity based service (Prose) service.

FIG. 13 is a schematic diagram of a structure of a communication device provided by an embodiment of the disclosure. As illustrated in FIG. 13, the device may include:
a transceiver module, configured to send a security policy for a first service, in which, the security policy for the first service is configured for multi-path transmission of the first service, the multi-path transmission of the first service includes a first path for communication between a first UE and a base station, and a second path for communication between the first UE and the base station via a second UE.

In summary, in the communication device provided in an embodiment of the present disclosure, the PCF network element may send the security policy for the first service, the security policy for the first service is configured for the multi-path transmission of the first service, the multi-path transmission of the first service includes the first path for communication between the first UE and the base station, and the second path for communication between the first UE and the base station via the second UE. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

Optionally, in an embodiment of the present disclosure, the security policy includes any one of:
required protection (REQUIRED); or
not needed protection (NOT NEEDED).

Optionally, in an embodiment of the present disclosure, the first path is a Uu link; the second path comprises a PC5 link between the first UE and the second UE and a Uu link between the second UE and the base station.

Optionally, in an embodiment of the present disclosure, the transceiver module is further configured to:
configure the security policy for the first service for the first UE and the second UE, respectively, wherein the security policy for the first service configured by the PCF network element for the first UE and the second UE is the same as a security policy for the first service configured by an SMF network element for the base station.

Optionally, in an embodiment of the present disclosure, the security policy includes at least one of:
a UP integrity protection and/or confidentiality protection policy for a PC5 link;
a UP integrity protection and/or confidentiality protection policy for a Uu link;
a signaling integrity protection and/or confidentiality protection policy for a PC5 link; or
a signaling integrity protection and/or confidentiality protection policy for a Uu link.

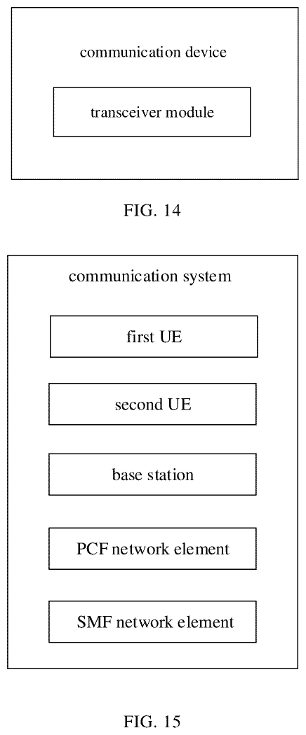

FIG. 14 is a schematic diagram of a structure of a communication device provided by an embodiment of the disclosure. As illustrated in FIG. 14, the device may include:
a transceiver module configured to send a security policy for a first service, wherein the security policy for the first service is configured for multi-path transmission of the first service, the multi-path transmission of the first service comprises a first path for communication between a first UE and a base station, and a second path for communication between the first UE and the base station via a second UE.

In summary, in the communication device provided in an embodiment of the present disclosure, the security policy for the first service is configured for the multi-path transmission of the first service, the multi-path transmission of the first service includes the first path for communication between the first UE and the base station, and the second path for communication between the first UE and the base station via the second UE. The security policy for the first service being configured for the multi-path transmission of the first service may be understood as that, the multi-path transmission is configured to serve the same first service, and one first service corresponds to one security policy, such that different paths in the multi-path transmission configured for the same first service may correspond to the same security policy (that is, the security policy sent by the PCF to the first UE and the second UE is the same as the security policy sent by the SMF to the base station). Based on this, establishing the multi-path transmission may be performed by establishing based on the same security policy, which may ensure that different paths in the multi-path transmission can use the same security policy. Further, the security policy of the present disclosure mainly includes REQUIRED or NOT NEEDED, rather than PREFERRED, therefore, the present disclosure may further ensure that different paths in the multi-path transmission can ensure the same security activation state, and further ensure information security during the multi-path transmission.

Optionally, in an embodiment of the present disclosure, the security policy includes any one of:
required protection (REQUIRED); or
not needed protection (NOT NEEDED).

Optionally, in an embodiment of the present disclosure, the first path is a Uu link; the second path comprises a PC5 link between the first UE and the second UE and a Uu link between the second UE and the base station.

Optionally, in an embodiment of the present disclosure, the transceiver module is further configured to:
configure the security policy for the first service for the base station, wherein the security policy for the first service configured by the SMF network element for the base station is the same as a security policy for the first service configured by a PCF network element for the first UE and the second UE.

Optionally, in an embodiment of the present disclosure, the security policy includes at least one of:
a UP integrity protection and/or confidentiality protection policy for a PC5 link;
a UP integrity protection and/or confidentiality protection policy for a Uu link;
a signaling integrity protection and/or confidentiality protection policy for a PC5 link; or
a signaling integrity protection and/or confidentiality protection policy for a Uu link.

FIG. 15 is a schematic diagram of a structure of a communication system provided by an embodiment of the disclosure. As illustrated in FIG. 15, the system may include:
an SMF network element, configured to send a security policy for a first service to a base station;
a PCF network element, configured to send the security policy for the first service to a first UE and a second UE;
a base station, configured to receive the security policy for the first service sent by the SMF network element;
a first UE, configured to receive the security policy for the first service sent by the PCF network element; and
a second UE, configured to receive the security policy for the first service sent by the SMF network element;
in which, the security policy for the first service is configured for multi-path transmission of the first service, the multi-path transmission of the first service includes a first path for communication between the first UE and the base station, and a second path for communication between the first UE and the base station via the second UE.

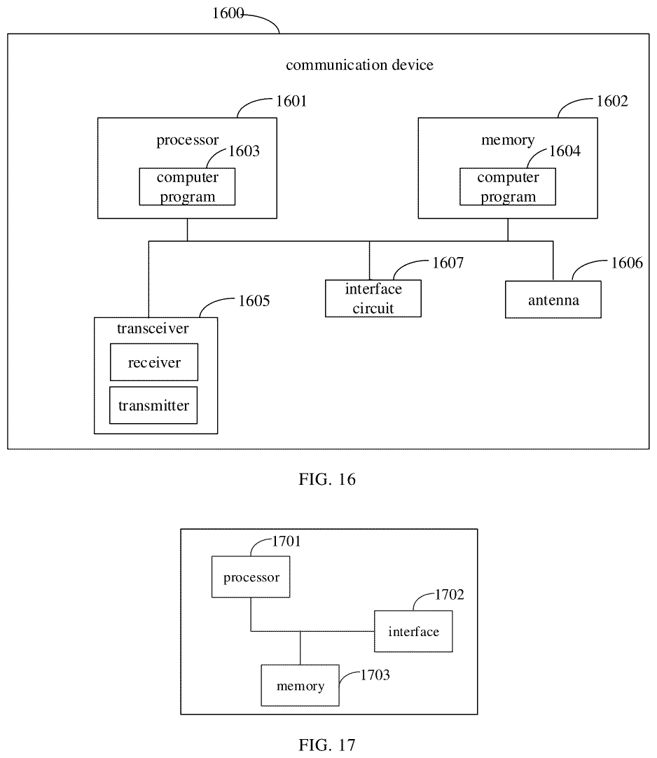

Please refer to FIG. 16, FIG. 16 is a structural diagram of a communication device 1600 provided by an embodiment of the disclosure. The communication device 1600 may be a base station or a terminal device, or may be a chip, a chip system or a processor that supports the base station to realize the above-described methods, or may be a chip, a chip system or a processor that supports the terminal device to realize the above-described methods. The communication device may be used to realize the methods described in the above method embodiments with reference to the description of the above-described method embodiments.

The communication device 1600 may include one or more processors 1601. The processor 1601 may be a general purpose processor or a dedicated processor, such as, a baseband processor and a central processor. The baseband processor is used for processing communication protocols and communication data. The central processor is used for controlling the communication device (e.g., a base station, a baseband chip, a terminal device, a terminal device chip, a DU, or a CU), executing computer programs, and processing data of the computer programs.

Optionally, the communication device 1600 may include one or more memories 1602 on which computer programs 1604 may be stored. The processor 1601 executes the computer programs 1604 to cause the communication device 1600 to perform the methods described in the above method embodiments. Optionally, the memory 1602 may also store data. The communication device 1600 and the memory 1602 may be provided separately or may be integrated together.

Optionally, the communication device 1600 may also include a transceiver 1605 and an antenna 1606. The transceiver 1605 may be referred to as a transceiver unit, a transceiver machine, or a transceiver circuit, for realizing a transceiver function. The transceiver 1605 may include a receiver and a transmitter. The receiver may be referred to as a receiving machine or a receiving circuit, for realizing the receiving function. The transmitter may be referred to as a transmitter machine or a transmitting circuit, for realizing the transmitting function.

Optionally, the communication device 1600 may also include one or more interface circuits 1607. The interface circuits 1607 are used to receive code instructions and transmit them to the processor 1601. The processor 1601 runs the code instructions to cause the communication device 1600 to perform the method described in the method embodiments.

In an implementation, the processor 1601 may include a transceiver for implementing the receiving and sending functions. The transceiver may be, for example, a transceiver circuit, an interface, or an interface circuit. The transceiver circuit, the interface, or the interface circuit for implementing the receiving and sending functions may be separated or may be integrated together. The transceiver circuit, the interface, or the interface circuit described above may be used for reading and writing code/data, or may be used for signal transmission or delivery.

In an implementation, the processor 1601 may store a computer program 1603. The processor 1601 runs the computer program 1603 to cause the communication device 1600 to perform the methods described in the method embodiments above. The computer program 1603 may be solidified in the processor 1601, and in such case the processor 1601 may be implemented by hardware.

In an implementation, the communication device 1600 may include circuits. The circuits may implement the sending, receiving or communicating function in the preceding method embodiments. The processor and the transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver are produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the description of the above embodiments may be a base station or a terminal device, but the scope of the communication device described in the disclosure is not limited thereto, and the structure of the communication device may not be limited by FIG. 16. The communication device may be a stand-alone device or may be part of a larger device. For example, the described communication device may be:
(1) a stand-alone integrated circuit (IC), a chip, a chip system or subsystem;
(2) a set of ICs including one or more ICs, optionally, the set of ICs may also include storage components for storing data and a computer program;
(3) an ASIC, such as a modem;
(4) a module that can be embedded within other devices;
(5) a receiver, a terminal device, a smart terminal device, a cellular phone, a wireless device, a handheld machine, a mobile unit, an in-vehicle device, a network device, a cloud device, an artificial intelligence device, and the like; and
(6) others.

For a case where the communication device is a chip or a chip system, reference may be made to a structural diagram of a chip as illustrated in FIG. 17. The chip illustrated in FIG. 17 includes a processor 1701 and an interface 1702. There may be may be one or more processors 1701, and a plurality of interfaces 1702.

Optionally, the chip further includes a memory 1703, the memory 1703 is configured to store necessary computer programs and data.

It is understood by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be understood as beyond the scope of protection of the embodiments of the disclosure.

The disclosure also provides a readable storage medium having instructions stored thereon. When the instructions are executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, the above embodiments may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., using coaxial cables, fiber optics, or digital subscriber lines (DSLs) or wireless manner (e.g., using infrared wave, wireless wave, or microwave). The computer-readable storage medium may be any usable medium to which the computer is capable to access or a data storage device such as a server integrated by one or more usable mediums and a data center. The usable medium may be a magnetic medium (e.g., a floppy disk, a hard disk, and a tape), an optical medium (e.g., a high-density digital video disc (DVD)), or a semiconductor medium (e.g., a solid state disk (SSD)).

Those skilled in the art understand that “first”, “second”, or other various numerical numbers involved in the disclosure are only described for the convenience of differentiation, and are not used to limit the scope of the embodiments of the disclosure, or used to indicate the order of precedence.

The term “at least one” in the disclosure may also be described as one or more, and the term “more” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in this disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in this disclosure may not be configured. For another example, the above tables may be adjusted appropriately, such as splitting, combining, and the like. The names of the parameters shown in the titles of the above tables may be other names that can be understood by the communication device, and the values or representations of the parameters may be other values or representations that can be understood by the communication device. Each of the above tables may also be implemented with other data structures, such as, arrays, queues, containers, stacks, linear tables, pointers, chained lists, trees, graphs, structures, classes, heaps, and Hash tables.

The term “predefine” in this disclosure may be understood as define, predefine, store, pre-store, pre-negotiate, pre-configure, solidify, or pre-fire.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above can be referred to the corresponding processes in the preceding method embodiments, and will not be repeated herein.

The above are only specific implementations of the disclosure, but the scope of protection of the disclosure is not limited thereto. Those skilled in the art familiar to this technical field can easily think of changes or substitutions in the technical scope disclosed by the disclosure, which shall be covered by the scope of protection of the disclosure. Therefore, the scope of protection of the disclosure shall be governed by the scope of protection of the appended claims.

1. A multi-path transmission method, comprising:
acquiring, by a first user equipment (UE), or a second UE, or a base station, a security policy for a first service, wherein the security policy for the first service is configured for multi-path transmission of the first service, the multi-path transmission of the first service comprises a first path for communication between the first UE and the base station, and a second path for communication between the first UE and the base station via the second UE; and
performing, by the first UE, or the second UE, or the base station, the multi-path transmission of the first service according to the security policy for the first service.

2. The method according to claim 1, wherein the security policy comprises any one of:
required; or
not needed.

3. The method according to claim 1, wherein the first path is a Uu link; the second path comprises a PC5 link between the first UE and the second UE and a Uu link between the second UE and the base station.

4. The method according to claim 1, wherein the security policy for the first service comprises at least one of the following policies:
a user plane (UP) integrity protection and/or confidentiality protection policy for a PC5 link;
a UP integrity protection and/or confidentiality protection policy for a Uu link;
a signaling integrity protection and/or confidentiality protection policy for a PC5 link; or
a signaling integrity protection and/or confidentiality protection policy for a Uu link.

5. The method according to claim 1, wherein acquiring the security policy for the first service comprises:
receiving, by the first UE, the security policy for the first service configured by a policy control function (PCF) network element for the first UE, wherein the security policy for the first service configured by the PCF network element for the first UE is the same as a security policy for the first service configured by a session management function (SMF) network element for the base station.

6. The method according to claim 1, further comprising:
receiving, by the first UE, first indication information sent by a PCF network element, wherein the first indication information indicates whether the first UE supports multi-path transmission capability; and
establishing, by the first UE, the multi-path transmission of the first service according to the first indication information.

7.-21. (canceled)

22. A multi-path transmission method, comprising:
sending, by a policy control function (PCF) network element or a session management function (SMF) network element, a security policy for a first service, wherein the security policy for the first service is configured for multi-path transmission of the first service, the multi-path transmission of the first service comprises a first path for communication between a first UE and a base station, and a second path for communication between the first UE and the base station via a second UE.

23. The method according to claim 22, wherein the security policy comprises any one of:
required; or
not needed.

24. The method according to claim 22, wherein the first path is a Uu link; the second path comprises a PC5 link between the first UE and the second UE and a Uu link between the second UE and the base station.

25. The method according to claim 22, wherein sending the security policy comprises:
configuring, by the PCF network element, the security policy for the first service for the first UE and the second UE, respectively, wherein the security policy for the first service configured by the PCF network element for the first UE and the second UE is the same as a security policy for the first service configured by an SMF network element for the base station.

26. The method according to claim 22, wherein the security policy comprises at least one of:
a UP integrity protection and/or confidentiality protection policy for a PC5 link;
a UP integrity protection and/or confidentiality protection policy for a Uu link;
a signaling integrity protection and/or confidentiality protection policy for a PC5 link; or
a signaling integrity protection and/or confidentiality protection policy for a Uu link.

27.-31. (canceled)

32. A communication device, comprising a processor and a memory having a computer program stored thereon, wherein the processor is configure to:
acquire a security policy for a first service, wherein the security policy for the first service is configured for multi-path transmission of the first service, the multi-path transmission of the first service comprises a first path for communication between the first UE and a base station, and a second path for communication between the first UE and the base station via a second UE; and
perform the multi-path transmission of the first service according to the security policy for the first service.

33. (canceled)

34. (canceled)

35. A communication device comprising a processor and a memory having a computer program stored thereon, wherein the processor is configure to perform the method according to claim 22.

36.-39. (canceled)

40. A computer-readable storage medium for storing instructions, which, when executed, causes the method according to any claim 1 to be implemented.

41. A computer-readable storage medium for storing instructions, which, when executed, causes the method of claim 22 to be implemented.

42. The method according to claim 1, wherein acquiring the security policy for the first service comprises:
receiving, by the second UE, the security policy for the first service configured by a PCF network element for the second UE, wherein the security policy for the first service configured by the PCF network element for the second UE is the same as a security policy for the first service configured by an SMF network element for the base station.

43. The method according to claim 1, further comprising:
establishing, by the second UE, a PC5 link between the second UE and the first UE; and
establishing, by the second UE, a Uu link between the second UE and the base station.

44. The method according to claim 1, further comprising:
receiving, by the base station, the security policy for the first service configured by an SMF network element for the base station, wherein the security policy of the first service configured by the SMF network element for the base station is the same as a security policy of the first service configured by a PCF network element for the first UE and the second UE.

45. The method according to claim 1, further comprising:
establishing, by the base station, a Uu link between the base station and the first UE; and
establishing, by the base station, a Uu link between the base station and the second UE.

46. The method according to claim 22, wherein sending the security policy comprises:
configuring, by the SMF network element, the security policy for the first service for the base station, wherein the security policy for the first service configured by the SMF network element for the base station is the same as a security policy for the first service configured by a PCF network element for the first UE and the second UE.
